(19) United States
(12) Patent Application Publication
(10) Pub. No.: US 2017/0266794 A1
(43) Pub. Date: Sep. 21, 2017

(54) Drive Element for Transmitting a Torque to a Threaded Insert Sleeve

(71) Applicant: Ludwig Hettich Holding GmbH & Co. KG, Schramberg-Sulgen (DE)

(72) Inventors: Ulrich Hettich, Schramberg (DE); Stefan Hettich, Schramberg (DE); Andreas Schwab, Dornhan (DE)

(21) Appl. No.: 15/461,588

(22) Filed: Mar. 17, 2017

(30) Foreign Application Priority Data
Mar. 17, 2016 (EP) 16160951.6

(51) Int. Cl. B25B 27/14; F16B 37/12

(52) U.S. Cl. CPC B25B 27/143; F16B 37/127

(57) ABSTRACT

A drive element is described for transmitting a torque to a threaded insert sleeve. A holder has a drive profile in which along a longitudinal axis of the drive element a drive tool for transmitting a torque from the drive tool to the drive element can be received. The longitudinal axis passes through the center of the drive profile and corresponds to a rotation axis of the drive element about which the drive element rotates when transmitting the torque from the drive tool to the drive element. An axial connecting section has an outer surface for forming a connection to the threaded insert sleeve that is one or more of a materially bonded, form-fitting and force-fitting connection. Via the outer surface, when a connection to a threaded insert sleeve is formed, a torque can be transmitted from the drive element to the threaded insert sleeve.

### TECHNICAL FIELD

The present invention is in the field of anchoring technology and comprises a drive element for transmitting a torque to a threaded insert sleeve, and also a threaded insert, which comprises the drive element and a threaded insert sleeve.

### BACKGROUND

In the prior art, threaded inserts are used as connecting elements for producing connections between components. The components to be connected can consist of the same or of different materials. Examples of such connections are connections between steel and plastic, between steel and aluminium, between steel and wood and wood and concrete. Of particular practical importance are threaded inserts with a self-tapping outer thread or a cutting outer thread, for screwing into masonry or concrete. Threaded inserts can be both pre-installed or embedded in the respective components for manufacturing purposes. They can also be installed retrospectively for repair purposes.

Threaded inserts usually comprise an internal (female) and an external (male) thread. To produce a connection, the threaded insert is screwed into a drilled hole using its external thread. A connecting bolt can then be screwed into the threaded insert to produce a connection to another component.

From the technology of the prior art, different threaded inserts and internal threaded anchors having an internal and an external thread are known. EP1085220B1, for example, discloses a threaded insert in the form of a stud anchor, which is fabricated from a solid workpiece.

DE10 2007054798B3 discloses a threaded insert in the form of a threaded insert sleeve, which is wound from a profiled strip. The internal thread and the external thread in this case are formed by corresponding profiles on both sides of the profiled strip. Such wound threaded insert sleeves require only a small amount of material and offer the advantage of comparatively inexpensive production. The previously mentioned wound threaded insert is only partially suitable for self-tapping screws, since the screwing torque cannot be readily transferred from a drive at the rear end via the wound profile strip onto the self-tapping region at the leading end of the threaded insert.

The problem is also compounded by the fact that the thread cutting requires a certain hardness of the cutting thread, which when using a steel thread can only be achieved by a high carbon content. In the case of a wound threaded insert made of steel, the high carbon content gives rise to a brittleness however, which hampers or prevents a transmission of the screw-in torque in the axial direction. Given the comparatively low wall thickness of the wound threaded insert, the wound material also tends not to harden exclusively on the surface, but is hardened across the entire cross-section of the profiled strip during the hardening process.

To solve this problem, in DE102013109987A1 a drive coil was proposed, which can be anchored in a leading region of a wound threaded insert sleeve over an outer profile. By using the outer profile, the torque can then be transmitted directly onto the threaded insert sleeve in the leading region of the drive coil without any torque transmission being required via the threaded insert sleeve in the axial direction.

### SUMMARY OF THE INVENTION

The object of the present invention is to provide an alternative advantageous solution for inserting a threaded insert sleeve.

This problem is solved by means of a drive element according to claim 1. Advantageous embodiments and further developments are specified in the dependent claims.

The present invention relates to a drive element for transmitting a torque to a threaded insert sleeve, which comprises a holder or receiving portion and an axial connecting section. The holder comprises a drive profile. In the holder, a drive tool can be received along a longitudinal axis of the drive element, for transmitting a torque from the drive tool to the drive element, wherein the longitudinal axis passes through the centre of the drive profile and corresponds to a rotation axis of the drive element, about which the drive element rotates when transmitting the torque from the drive tool to the drive element. The axial connecting section has an outer surface for forming a materially bonded, positive-fitting and/or force-fitting connection to the threaded insert sleeve, wherein via the outer surface, when a connection to a threaded insert sleeve is formed, a torque can be transmitted from the drive element to the threaded insert sleeve. The drive element has, at least in some sections, a cross-sectional area in which a circular line can be inscribed with a centre through which the rotational axis passes. In other words, the longitudinal axis passes through the centre of the circle which is defined by the circular line. The centre or the central point of the circular line does not necessarily also have to lie in the cross-sectional area.

Because the outer surface of the connecting section is suited to a materially bonded, positive-fitting and/or force-fitting connection to a threaded insert sleeve, the drive element can be connected to the threaded insert sleeve via an appropriately designed connection in the region of a leading end of the threaded insert sleeve, or anchored therein. By means of a drive tool that can be received in the holder or receiving portion of the drive element, and in doing so can engage with the drive profile, a torque can then be transmitted from the drive tool to the drive element. Via the connection the torque in the leading region of the threaded insert sleeve can be transmitted from the drive element onto the threaded insert sleeve.

The torque transmission from the drive element to the threaded insert sleeve can therefore take place exclusively or at least primarily in the radial direction and need not take place in the longitudinal direction along the threaded insert sleeve toward the leading end of the threaded insert sleeve. The drive element according to the invention is therefore suitable also for inserting hardened, brittle threaded insert sleeves, wherein the insertion can be effected using a self-tapping thread or thread cutting by means of the outer thread of the threaded insert sleeve.

In contrast to the above mentioned drive coil, the drive element according to the invention has, at least in some sections, a cross-sectional area in which a circular line can be inscribed, through the centre or central point of which the rotational axis passes. The cross-sectional area in this case corresponds to the surface which is arranged in a sectional plane through the drive element perpendicular to the longitudinal axis of the drive element, and defines the material arrangement of the drive element in this sectional plane. In other words, at least on one section of the drive element a part of the material of the drive element is arranged in the shape of a closed ring around the axis of rotation, without the perimeter line of the outer shape of this section also having to be circular. This provides a particularly good stability during a transmission of torque and during a rotation about the axis of rotation. In particular, a torsion, an axial strain or a deformation of the drive element can be relatively easily prevented, in particular in the case of a torque transmission due to a rotation about the axis of rotation for the purposes of insertion or thread cutting.

In addition, on the basis of the above cross-sectional area the drive element also has a closed outer surface around the axis of rotation, via which it can be possible to produce the previously mentioned connection to the threaded insert sleeve. In the case of a connection via a closed surface which extends annularly around the axis of rotation, the threaded insert sleeve can be particularly well supported and stabilized. This also allows threaded insert sleeves with low stability or mechanical strength, in particular also thin, brittle, wound threaded insert sleeves, to be reliably screwed into drilled holes or “drawn” into the holes via their leading end.

The outer surface of the connecting section can be smooth and/or profiled. A smooth surface is particularly well suited for a materially bonded connection or joint using a joining means, for example, glue or solder, since the joining means can spread and propagate well along a smooth surface or section of a smooth surface. A profiled surface is particularly well suited to a positive-fitting or form-fitting connection to a surface with a matching profile. The outer surface can also be profiled and at the same time comprise smooth surface sections. This means that the two previously mentioned benefits can be combined to form a connection which is both materially bonded and positive-fitting. These above-mentioned connections allow a transmission of high torque values against high resistances, such as can occur when cutting threads.

The drive element is preferably formed from a solid workpiece. Other than the above-mentioned drive coil that is bent from a profiled or sheet metal strip, the drive element can therefore be produced from the whole piece with a suitable production method. This allows for an particularly good stability and rigidity.

The length of the connecting section can be, for example, one to three times its diameter, for example 1.5 times. A shorter length means that a greater length is available within the thread insert sleeve to be connected, which can be used for a connection construction, for example by means of a load-bearing internal thread. A larger length on the other hand allows a stronger connection between the drive element and the threaded insert sleeve, which means that higher torques can be transmitted, in particular against resistances, when cutting threads. The above-mentioned length range thus offers an optimal compromise for many advantageous applications.

In one advantageous embodiment, the outer surface of the connecting section comprises projections that protrude radially outwards for a torque transmission via a positive-fitting connection to threaded insert sleeve. This allows a positive-fitting connection between the drive element and the threaded insert sleeve in which the projections engage in a corresponding mating profile or in corresponding recesses in the area of the leading end of the threaded insert sleeve. This can enable a positive force transmission to take place. The outer surface with the outwardly protruding projections can have, for example, the shape of a multi-toothed profile or of a polygon.

In the above-mentioned embodiment the projections preferably extend over the connecting section in the longitudinal direction. This will provide more surface area for a positive force transmission in the circumferential direction perpendicular to the axis of rotation.

In one or more of the above-mentioned embodiments the external shape of the connecting section can have translational symmetry in the longitudinal direction. In other words, the profile of the perimeter of the connecting section along the longitudinal direction does not change, so that the external shape of the connecting section is cylindrical, regardless of whether and to what extent the holder extends through the connecting section. This allows the connecting section to be inserted axially, i.e. in the longitudinal direction, into a cylindrical or substantially cylindrical threaded insert sleeve, wherein a uniform positive-fitting engagement with a corresponding mating profile is possible over the length of the connecting section and/or a uniform joint gap or a uniform contact can be provided over the length of the connecting section for a materially bonded connection.

It should be noted that the drive element according to the invention is preferably used with threaded insert sleeves that have a substantially circular-cylindrical outer surface and a circular-cylindrical or substantially circular-cylindrical interior surface. The deviation relative to an exact cylindrical form, in which the outer or inner profile does not change in the longitudinal direction and in which the outer or inner shape is translationally symmetric in the longitudinal direction, is preferably formed primarily by the existing external thread and—if present—by the internal thread of the threaded insert sleeve. It is pointed out that a “cylinder” within the meaning of this disclosure also covers such cylinders as are not circular-cylindrical and have cross-sections which may differ from a circular shape.

The drive profile of the holder can be an internal hexalobular profile, an internal polyhedral profile or an internal polygonal profile. These are common profiles that can be used advantageously for transmitting a torque.

The holder of the drive element according to the invention can be formed by a through hole or a blind hole, the through hole preferably being tapered, at least in some sections, along the longitudinal direction and/or having a shoulder. Either by means of a blind hole, a tapering in a through hole, or by a shoulder in a through hole, a stop can be formed that prevents a drive tool, whose shape is translationally symmetric in the longitudinal direction, from being pushed through the drive element. In alternative embodiments however, the through hole can also have a constant cross-section along the longitudinal direction, or else it can be translationally symmetric in the longitudinal direction. In such embodiments a stop can be formed by a taper or a shoulder of a corresponding drive tool which is not translationally symmetric.

In one or more of the above-mentioned embodiments or in any of the other embodiments, the outer surface of the connecting section has three or more surface lines extending in a longitudinal direction, which lie on an imaginary envelope or “bounding” surface having the form of a perpendicular circular cylinder. The outer surface is spaced apart from the imaginary envelope surface on surface sections, each of which is between two radially adjacent surface lines, so that imaginary channels are formed between the imaginary envelope surface and the outer surface of the connecting section. Such a form is particularly advantageous for a good and uniform materially bonded connection to a cylindrical or substantially cylindrical internal surface of a threaded insert sleeve. The connecting section in this case can be secured against a lateral displacement and against tilting along the surface lines within the threaded insert sleeve extending in the longitudinal direction, and held in a defined position. Between the surface sections mentioned and the internal wall of the threaded insert sleeve, channels are formed into which a joining means can be introduced or can be drawn in via a capillary effect.

In the above-mentioned embodiment, the external surface of the connecting section can have an outer polyhedral profile or an outer polygonal profile.

In an advantageous further development, the drive element comprises an axial locking section, which adjoins the connecting section and which in the region of the boundary with the imaginary channels is spaced a smaller distance apart from or no distance apart from the continuation of the imaginary envelope or “bounding” surface. The locking section can prevent a joining means, such as solder or adhesive, or a melt from flowing into the interior of the threaded insert sleeve when producing a materially bonded connection. This can prevent an internal thread or interior of the threaded insert sleeve, which is required for a later connection construction, from being closed off or made unusable.

In an advantageous further development, the drive element further comprises an axial thread section with an external thread, wherein the thread section is arranged closer to a leading end of the drive element than the connecting section and wherein a thread inner diameter of the threaded section is greater than an outer diameter of the connecting section. The external thread of the threaded section can enable a thread cutting function. This drive element can therefore be used for self-tapping threaded inserts, in which the thread cutting is performed by the drive element and not by the external thread of the threaded insert sleeve. This also allows thread insert sleeves to be used that are made of corrosion-resistant materials, e.g. from stainless steels, which usually are not able to be tempered and are therefore not suitable for thread cutting. For the threaded insert sleeves other materials which are not suitable for thread cutting can also be used, such as plastics.

In the above-mentioned embodiment the maximum outer diameter of the threaded section can be smaller in the direction of the leading end of the drive element. This facilitates insertion into a drilled hole and simplifies thread cutting.

In one or both of the above embodiments, the external thread can comprise at least half a turn of the thread, particularly preferably at least a whole turn. This allows the external thread of the threaded section to be long enough to be able to cut a thread.

In one or more of the above embodiments, the outer thread of the threaded section can have self-tapping teeth. These give rise to a simplification of the thread cutting.

In one or more of the four above-mentioned embodiments, the drive element can be formed from two or more pieces, with an inner element having the connecting section and with an outer element for forming the threaded portion, which surrounds the inner element at least in some sections. This enables only the outer element to be hardened for hardening the outer thread of the threaded section. In addition, the inner element and the outer element can be produced independently of each other with different production processes and only subsequently be connected to each other.

In some of the above-mentioned embodiments the connecting section can be the same length as the drive element. In these embodiments the drive element can be introduced completely into a threaded insert sleeve, wherein a materially bonded, force-fitting and/or positive-fitting connection can be established between the threaded insert sleeve and the drive element over the entire length of the drive element.

In one preferred embodiment the driving element is constructed integrally. This allows better stability and manufacturability, because no individual elements have to be connected to each other.

In one or more of the above embodiments the driving element is completely or partly formed from a temperable metal. After the temperable metal has been hardened, it can have a hardness of, for example, ≧50 HRC, where HRC designates the Rockwell hardness according to ISO 6508-1 (1997). This is particularly advantageous when the drive element is used for thread cutting. If the drive element is constructed of multiple pieces and has an external thread then only the piece that forms the external thread, for example, can also be formed from a temperable metal.

The present invention also comprises a threaded insert for insertion into a drilled hole, which comprises a threaded insert sleeve with an external thread and which comprises a drive element according to one or more of the above-mentioned embodiments. In the thread insert according to the invention, the connecting section is arranged in the leading half, preferably at the leading end of the threaded insert sleeve inside the threaded insert sleeve, and the connecting section is connected via a positive-fitting, materially bonded and/or force-fitting connection to the threaded insert sleeve, in such a way that a torque transmitted to the drive element via the drive profile is transmitted from the drive element onto the threaded insert sleeve.

In an advantageous design the inner side of the threaded insert sleeve comprises a plurality of recesses, which are shaped and arranged in correspondence with the radially outwardly protruding projections of the connecting section, wherein the projections are received in the recesses, so that a positive-fitting connection exists. This positive-fitting connection allows a transmission of force in the circumferential direction.

In addition or alternatively, between the outer surface of the connecting section and the threaded insert sleeve a materially bonded connection exists, which is formed by soldering, bonding or welding.

In one or more of the above embodiments, the threaded insert sleeve can be at least partially formed from a different material than the drive element, wherein the threaded insert sleeve preferably consists of a corrosion-resistant metal, particularly preferably of stainless steel, or of plastic, or comprises one of these materials. Because a corrosion-resistant threaded insert sleeve is not itself suitable for thread cutting, this can be used in a particularly advantageous way in combination with a drive element which is suitable for thread cutting and which therefore necessarily consists of a different material.

The threaded insert sleeve can comprise a wound metal strip or consist thereof and/or can comprise an internal thread. A wound threaded insert sleeve requires a particularly small amount of material and is inexpensive to produce. An internal thread may be used for producing an anchor fixing.

In one or more of the above-mentioned embodiments the external thread on the threaded section can continue the external thread of the threaded insert sleeve, preferably having the same pitch as the external thread of the threaded insert sleeve. This allows the external thread of the drive element to be used for cutting an internal thread in a drilled hole, wherein the subsequent external thread of the threaded insert sleeve can engage comparatively easily with the tapped internal thread and be screwed or tightened up.

In an advantageous extension, the connecting section comprises an external thread which corresponds to the internal thread of the threaded insert sleeve, and a positive-fitting screw connection exists between the connecting section and the threaded insert sleeve. In this embodiment therefore, no additional mating profile needs to be introduced into the threaded insert sleeve. Instead, the positive-fitting connection can be produced using an already existing internal thread of the threaded insert sleeve.

The present invention also comprises a use of a drive element according to one or more of the above-mentioned embodiments for transmitting a torque to a threaded insert sleeve, in particular in a threaded insert according to one or more of the above-mentioned embodiments.

### BRIEF DESCRIPTION OF THE FIGURES

Additional advantages and features become apparent from the following description, in which exemplary embodiments are explained in more detail by reference to the attached figures. Identical elements in the figures are designated with the same reference numeral.

FIGS. 1A-1E show different views of a drive element according to the invention in accordance with a first embodiment.

FIGS. 2A-2C show different views of a threaded insert sleeve which can be used with the drive element of FIG. 1.

FIGS. 3A-3C show different views of a threaded insert, which comprises the drive element of FIG. 1 and the threaded insert sleeve of FIG. 2.

FIGS. 4A-4D show different views of a drive element according to the invention in accordance with a second embodiment.

FIGS. 5A-5B show different views of a threaded insert sleeve which can be used with the aid of the drive element of FIG. 4.

FIGS. 6A-6C show different views of a threaded insert according to the invention, which comprises the drive element of FIG. 4 and the threaded insert sleeve of FIG. 5.

FIGS. 7A-7D show different views of a drive element according to the invention in accordance with a third embodiment.

FIGS. 8A-8I show a first further development of the drive element according to the invention of FIG. 4.

FIGS. 9A-9H show a second extension of the drive element according to the invention of FIG. 4.

### DETAILED DESCRIPTION OF EXEMPLARY EMBODIMENTS

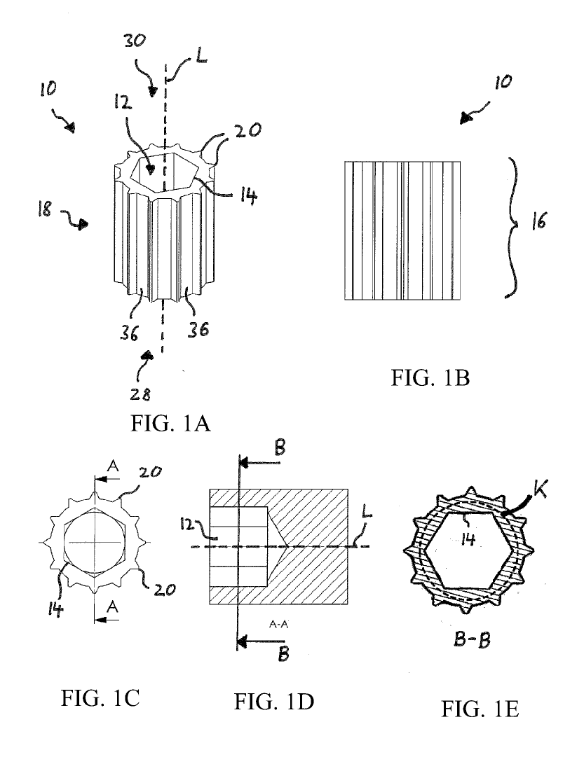

FIGS. 1A-1E show different views of a drive element 10 according to the invention in accordance with a first embodiment. FIG. 1A shows the drive element 10 in a perspective inclined view from above, FIG. 1B shows the drive element 10 from the side, FIG. 1C shows the drive element 10 in plan view, FIG. 1D shows a view of a longitudinal section through the drive element 10 along the plane A-A shown in FIG. 1C and FIG. 1E shows a cross section through the drive element 10 along the plane B-B shown in FIG. 1D.

The drive element 10 has a holder 12 (receiving section) with a drive profile 14. In the embodiment of FIGS. 1A-1E the drive profile 14 has the shape of a hexagonal socket. In other embodiments the drive profile 14 can have a different shape, for example the shape of an internal hexalobular profile or an internal polyhedral profile or an internal polygonal profile, which do not necessarily have to be internal hexagonal profiles. As can be seen in FIG. 1D, the holder 12 is formed by a blind hole that extends into the drive element 10 up to a certain depth, but does not penetrate it.

The drive element 10 also comprises an axial connecting section 16, which in the embodiment of FIGS. 1A-1E extends over the entire length of the drive element 10.

In this disclosure a “length” of a drive element refers to a dimension of the drive element in a longitudinal direction of the drive element. The longitudinal direction of the drive element 10 is defined by the direction of the longitudinal axis L, wherein the longitudinal axis L corresponds to a rotational axis about which the drive element rotates during a torque transmission from a suitable drive tool (not shown) onto the drive element 10 and from the drive element 10 onto a threaded insert sleeve. The dimension of the drive element in the longitudinal direction must therefore not necessarily be greater than the dimension of the drive element in the transverse direction. The longitudinal axis L passes through the centre or central point of the drive profile 14.

The longitudinal axis L is an axis of symmetry of the drive profile 14, wherein the symmetry for the example of the internal hexagonal profile of the drive element 10 of FIGS. 1A-1E is a six-fold symmetry. In other embodiments the symmetry may be a different type, which corresponds to the respective numerical degree of the respective drive profile.

The drive element 10 has a cylindrical shape with the longitudinal axis L as a central axis, wherein the outer shape of the drive element 10 is translationally symmetric in the longitudinal direction, as as is evident in FIG. 1A.

The connecting section 16 has an outer surface 18, over which a connection to a threaded insert sleeve can be produced. In the embodiment of FIGS. 1A-1E the outer surface 18 is profiled and comprises a plurality of projections 20, which either protrude radially outwards or extend radially outwards. The direction “radially outwards” here designates a direction that is perpendicular to the longitudinal axis L and faces away from the longitudinal axis L. In the embodiment of FIGS. 1A-1E the projections 20 also extend in the longitudinal direction, so that over the length of the connecting section 16 each of the projections 20 provides a surface that faces at least partly in the circumferential direction, and is therefore suitable for a torque transmission in the event of a rotation about the longitudinal axis L. The circumferential direction in this case is perpendicular to the longitudinal axis L and perpendicular to the radial direction at the location of the respective surface.

The cross-sectional area shown in FIG. 1E, which is obtained if a section is taken through the connecting cross section 16 transversely or perpendicular to the longitudinal axis L, is bounded to the inside by the drive profile 14 and is bounded to the outside by the profile of the outer surface 18. In this cross-section surface an imaginary circular line K can be inscribed, through the centre of which the longitudinal axis L passes. Because the cross-sectional area is defined by the material distribution which is present or the specific arrangement of the material, a part of the material of the drive element 10 is therefore arranged in a circle in a closed ring around the longitudinal axis L. Such a closed, continuous and circular material arrangement about a longitudinal axis L, which can be used as a rotational axis, offers a particularly good dimensional stability and rigidity that is highly resistant against deformation.

As indicated by FIGS. 1A and 1D, in the drive element 10 of FIGS. 1A-1E a circular line K can be inscribed in each cross section about an associated centre, through which the longitudinal axis L passes.

In the case of other embodiments that are not shown, a circular line K around the longitudinal axis L can also be inscribed in the cross-sections of the corresponding section only in some sections, wherein in the cross-sections of one or more other axial sections, no circular lines can be drawn with a corresponding centre through which the longitudinal axis L passes. These sections of these other embodiments not shown therefore contain no material which is arranged in a closed circle about the longitudinal axis L.

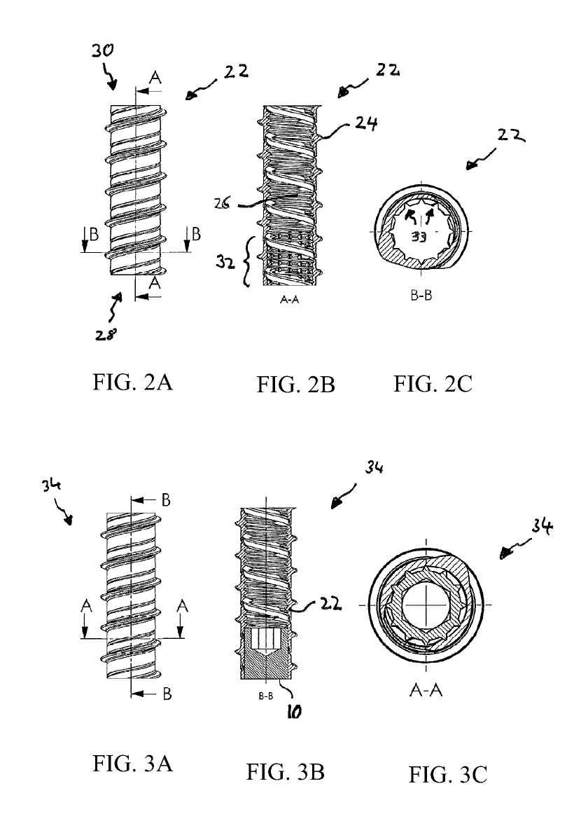

The FIGS. 2A-2C show a threaded insert sleeve 22 in a side view from the outside (FIG. 2A), in a longitudinal sectional view for a longitudinal section along the plane A-A (FIG. 2B) shown in FIG. 2A and in a cross-sectional view for a cross section along the plane B-B (FIG. 2C) shown in FIG. 2A.

The threaded insert sleeve 22 has an external thread 24 and an internal thread 26. The threaded insert sleeve 22 shown in FIGS. 2A-2C is formed by a wound profiled strip which is preferably made of steel. The external thread 24 and the internal thread 26 are formed in this case by a corresponding profiling of the profiled strip. The threaded insert sleeve 22 has a leading end 28 and a trailing end 30, which is located opposite the leading end 28 in the longitudinal direction. The leading end 28 is the end which, when inserting the threaded insert sleeve 22, leads into a drilled hole and which in doing so, points into the drilled hole.

The threaded insert sleeve 22 of FIGS. 2A-2C is a threaded insert sleeve which is designed for making a connection with the drive element 10 of FIGS. 1A-1E. For this connection, recesses 33 are incorporated into a leading axial region 32 of the threaded insert sleeve 22, which form a mating profile in the form of an internal profile for the profile of the outer surface 18 of the connecting element 10 of FIGS. 1A-1E. The recesses 33 are slots cut out from the thread pitches of the internal thread 26, which are aligned in the longitudinal direction with other recesses 33 of other longitudinal positions.

The length of the leading region 32, in which the recesses 33 are incorporated, is the same as the length of the drive element 10. This enables the drive element 10 to be inserted from the leading end 28 into the threaded insert sleeve 22 in a longitudinal direction, without the drive element 10 having to be rotated about its longitudinal axis L, or having to be rotated in relation to the threaded insert sleeve 22. If the drive element 10 is inserted into the threaded insert sleeve 22 over its length, a further displacement to the rear end 30 will be prevented in a positive-fitting manner, because the corresponding recesses 33 are only incorporated in the leading region 32. At the rear end of the leading region 32 therefore, a stop exists for the corresponding drive element 10.

FIGS. 3A-3C show a threaded insert 34 according to the invention, which comprises the drive element 10 of FIGS. 1A-1E and the threaded insert sleeve 22 of FIGS. 2A-2C, wherein the drive element 10 is arranged in the leading region 32 inside the threaded insert sleeve 22 and is connected thereto. FIG. 3A shows an external side view, FIG. 3B a view of a longitudinal section along the plane B-B shown in FIG. 3A and FIG. 3C shows a view of a cross section along the plane A-A shown in FIG. 3A.

If the drive element 10, as previously described, is inserted into the threaded insert sleeve 22, the projections 20 engage with corresponding recesses 33, so that a relative rotation between the drive element 10 and the threaded insert sleeve 22 around the longitudinal axis L is positively prevented. A rotation about the longitudinal axis L of the drive element 10 is therefore transmitted via the profiled outer surface 18 onto the insert sleeve 22.

In the threaded insert 34, in which the drive element 10 and the threaded insert sleeve 22 are connected, the longitudinal axis L of the drive element 10 and the longitudinal axis of the threaded insert sleeve 22 coincide and form a longitudinal axis L of the threaded insert 34, which at the same time is an axis of rotation of the threaded insert 34 and the threaded insert sleeve 22.

The connection between the drive element 10 and the threaded insert sleeve 22 can be either an exclusively positive-fitting one, or else it can be a combination of a form-fitting and a materially bonded connection.

When connected to the threaded insert sleeve 22, the driving element 10 is also secured against a displacement in the axial direction along the longitudinal axis L, so that the drive element 10 cannot be pushed out of the threaded insert sleeve 22 towards the leading end 28. Such an exclusively positive-fitting connection can be achieved in the embodiment of FIGS. 3A-3C, for example, by the threaded insert 34 in the leading region 32 of the threaded insert sleeve 22 being slightly bent.

In other embodiments in which the projections 20 of the drive element are not translationally symmetric in the longitudinal direction, an exclusively positive-fitting connection can also be achieved by the profile strip for forming the threaded insert sleeve 22 or for forming the threaded insert 24 being wound around the drive element, wherein a mating profile designed to correspond to the non-translationally symmetric projections is incorporated in the profile strip. The resulting positive-fitting connection can also prevent any axial movement both towards the trailing end 30 and towards the leading end 28 of the drive element.

An additional materially bonded connection between the drive element 10 and the threaded insert sleeve 22 may be produced, for example, by welding, soldering or by adhesive bonding. As shown in FIG. 1A, the outer surface 18 has smooth surface sections 36 between adjacent projections 20, which in each case extend between 2 projections 20 in the longitudinal direction. Along these surface sections 36 a joining means, for example, solder, glue or a melt, can readily spread in the longitudinal direction and and be distributed over the surface sections 36, in order to produce an additional materially bonded connection between the outer surface 18 and the threaded insert sleeve 22, or part of the inner surface thereof. Such a materially bonded connection can prevent the drive element 10 from slipping out longitudinally from the rear end 30 towards the leading end 28. The materially bonded connection can also contribute to the torque transmission from the drive element 10 to the threaded insert sleeve 22.

To insert or screw in the threaded insert 34 of FIGS. 3A-3C into a workpiece, the threaded insert 34 is first of all placed with its leading end 28 against a particular drilled hole. Screwing in the drive element is effected using a drive tool, which is inserted from the trailing end 30 through the threaded insert sleeve 22 into the holder 12 of the drive element 10 and which engages in the drive profile 14 of the holder 12 over a corresponding drive profile. By rotating the drive tool about the longitudinal axis L, a torque is transmitted onto the drive element 10. Due to the connection between the drive element 10 and the threaded insert sleeve 22, the torque is transmitted via the outer surface 18 of the connecting section 16 of the drive element 10 in the leading region 32 of the threaded insert sleeve 22 onto the threaded insert sleeve 22.

This torque transmission takes place in a radial direction in the region of the leading end 28 of the threaded insert sleeve 22. Due to the cylindrically arranged material of the drive element 10, the threaded insert sleeve 22 in this region is very well stabilized and supported, so that the threaded insert sleeve 22 can also be formed from a hardened profile strip and the external thread 24 in the leading region 32 can be used for cutting the thread.

It is pointed out that drive elements according to the invention, in particular also the example drive elements 10, 110, 210 described in detail, can also be used advantageously for inserting other threaded insert sleeves. For example, for threaded insert sleeves made of plastic.

Suitable threaded insert sleeves can also be cast or produced from a solid block of material by material removal, and do not have to be wound nor be suitable for thread cutting.

Since the holder 12 of the drive element 10 is formed by a blind hole, the drive tool cannot be pushed through the drive element 10 in the longitudinal direction, but is stopped thereby.

In other embodiments, the holder 12 can also be formed by a through hole that tapers in the direction of the leading end 28 of the drive element 10 and/or in which a stop is designed in the shape of a shoulder. This can also prevent a corresponding drive tool from being pushed through the drive element 10. In other embodiments the holder 12 can also be formed by a translationally symmetric through hole with constant cross-section. In such embodiments a stop can be formed by a taper or a shoulder of a corresponding drive tool which is not translationally symmetric.

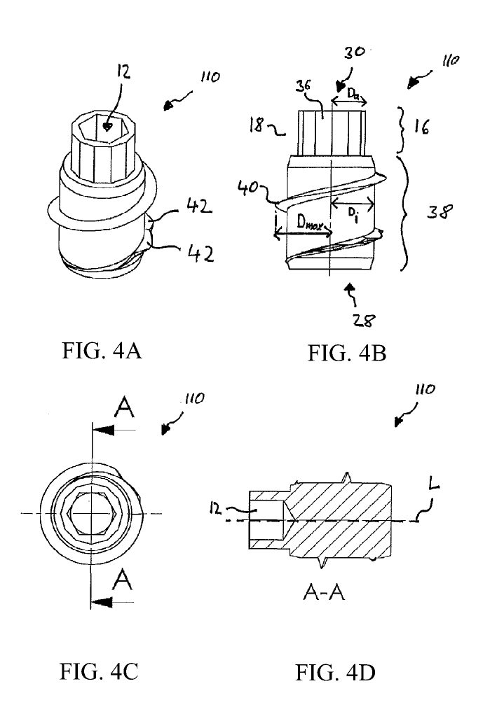

FIGS. 4A-4D show a drive element 110 in accordance with a second embodiment according to the invention in a perspective external view (FIG. 4A), in a side view (FIG. 4B), in plan view (FIG. 4C) and also in a sectional view for a section along the plane A-A (FIG. 4D) shown in FIG. 4C. The drive element 110 comprises an axial connecting section 16 and an axial threaded section 38 with an external thread 40. The threaded section 38 is arranged nearer to a leading end 28 of the drive element 110 arranged than the connecting section 16. In the embodiment of FIGS. 4A-4D the connecting section is located at the trailing end 30 of the drive element 110 and the threaded section 38 at the leading end 28 of the drive element 110.

As shown in FIG. 4B, is a thread inner diameter Dᵢ of the threaded section 38 is greater than an outer diameter Dₐ of the connecting section 16. This causes a shoulder to be formed between these sections, with which the drive element 110 can impinge upon the leading end of the threaded insert sleeve on being introduced into a suitable threaded insert sleeve.

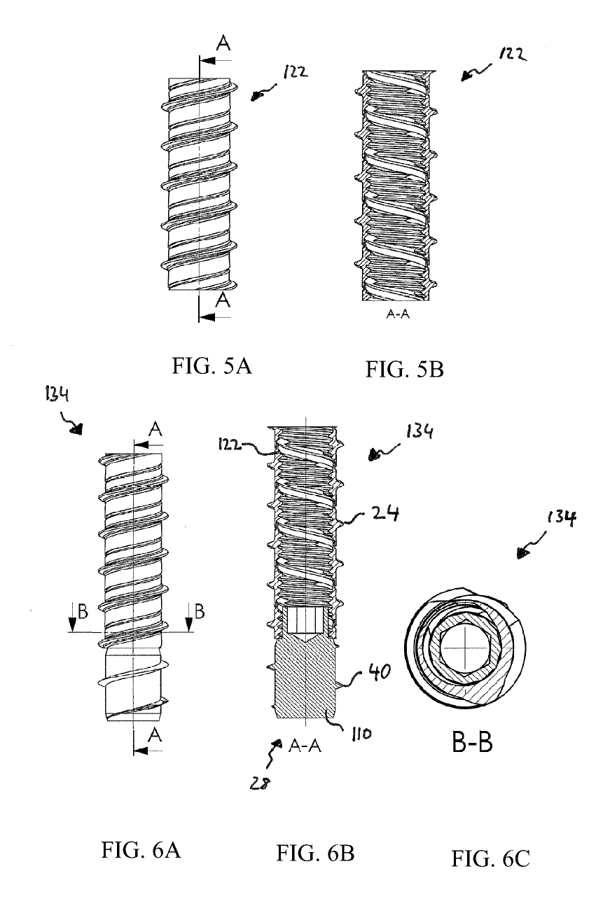

FIGS. 5A-5b show a threaded insert sleeve 122 in side view (FIG. 5A) and in a longitudinal view for a section along the plane A-A shown in FIG. 5A (FIG. 5B). The threaded insert sleeve 122 is designed for a connection to the drive element 110 of FIGS. 4A-4D and essentially differs from the threaded insert sleeve 22 in FIGS. 2A-2C in the fact that no mating profile with recesses 33 has been introduced into the threaded insert sleeve 122.

FIGS. 6A-6C show a threaded insert sleeve 134 according to the invention in accordance with a second embodiment according to the invention in a side view (FIG. 6A), in a longitudinal sectional view for a section along the plane A-A (FIG. 6B) shown in FIG. 6A, and in a cross-sectional view for a section along the plane B-B (FIG. 6C) shown in FIG. 6A. The threaded insert 134 comprises the threaded insert sleeve 122 of FIGS. 5A-5B and the drive element 110 of FIGS. 4A-4D.

In the threaded insert 134 the drive element 110 and the threaded insert sleeve 122 are connected to each other via a materially bonded connection. This connection is suitable for transmitting a torque, as previously described, from the drive element 110 in a leading region of the threaded insert sleeve 122 in a radial direction onto the threaded insert sleeve 122.

In the threaded insert 134, in which the drive element 110 and the threaded insert sleeve 122 are connected, the longitudinal axis L of the drive element 110 and the longitudinal axis of the threaded insert sleeve 122 coincide and form a longitudinal axis L of the threaded insert 134, which at the same time is an axis of rotation of the threaded insert 134 and the threaded insert sleeve 122.

The materially bonded connection can be produced by means of a joining means, which distributes itself and spreads over the smooth surface sections 36 of the outer surface 18 of the connecting section 16, between the connecting section 16 and an inner surface of the threaded insert sleeve 122. The materially bonded connection can also be produced using a welding process, wherein the melt resulting from the welding can spread and be distributed along the smooth surface sections 36 to produce a reliable connection.

In other embodiments not shown, the entire outer surface 18 of the connecting section 16 can also be smooth, without any edges or profiles being provided therein.

In still other forms not shown, the entire outer surface 18 of the connecting section 16 can also be profiled in such a way that that no smooth surface sections 36 are provided that extend in the longitudinal direction and are suitable for the spreading and distribution of a joining means. In these embodiments, the connection between the drive element and the threaded insert sleeve is preferably exclusively positive-fitting.

In the threaded insert 134 of FIGS. 6A-6C, the external thread 40 of the drive element 110 has the same pitch as the external thread 24 of the threaded insert sleeve 22. The external thread of the 40 forms a continuation of the external thread 24 in the direction of the leading end 28 of the drive element 110, which is also the leading end 28 of the threaded insert 134. Thus, the external thread 24 and the external thread 40 together form a continuous thread of the threaded insert 134, wherein the leading part of this composite thread is formed by the external thread 40 of the drive element 110.

Therefore, in the threaded insert 134 the drive element 110 can be used for cutting a thread, whereas the external thread 24 of the threaded insert sleeve 122 may not be suitable for thread cutting. The drive element 110 can therefore be used particularly advantageously in combination with corrosion-resistant untempered threaded insert sleeves 122, which on account of their material are not suitable for thread cutting. In other words, despite the corrosion resistance of its threaded insert sleeve 122, the threaded insert 134 can be used to cut a thread in a drilled hole, wherein the corrosion resistant external thread 124 can be screwed or drawn into an internal thread that was cut by the external thread 40.

A maximum external diameter Dₘₐₓ of the threaded section 34 preferably decreases in the longitudinal direction towards the leading end 28 of the threaded portion 38, as is shown in FIG. 4b. In addition, the external thread 40 of the drive element 110 preferably has self-tapping teeth 42 in a leading region, as is shown in FIG. 4a. The tapering outer diameter and the self-tapping teeth facilitate cutting a thread using the drive element 110.

In addition, the driving element 110 is preferably produced from a temperable material and is hardened when used in the threaded insert 134, which means a reliable thread cutting with a metal drive element 110 can be facilitated or improved.

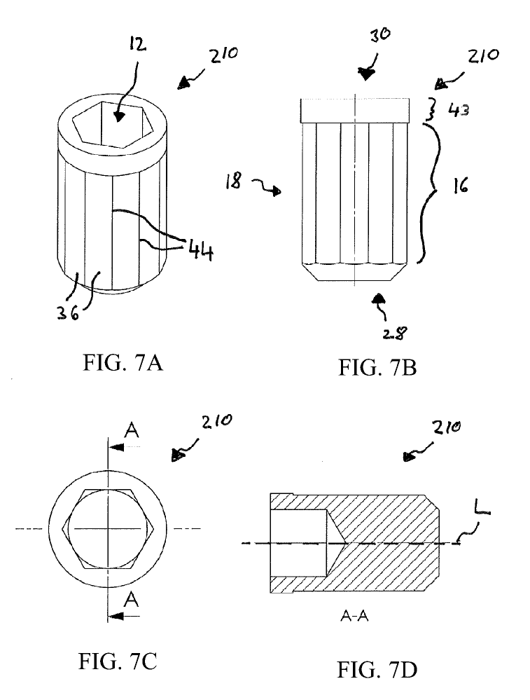

FIGS. 7A-7D show a drive element 210 in accordance with a third embodiment according to the invention in a perspective external view (FIG. 7A), in a side view (FIG. 7B), in plan view (FIG. 7C) and also in a longitudinal sectional view for a section along the plane A-A shown in FIG. 7C (FIG. 7D).

The drive element 210 is particularly suitable for a materially bonded connection to a threaded insert sleeve, for example the threaded insert sleeve 122 of FIGS. 5A-5B.

The drive element 210 comprises a connecting section 16 and an axial locking section 43 in the form of a cylindrical flange. The locking section 43 is arranged closer to a trailing end 30 of the drive element 210 than the connecting section 16 and is adjacent to the connecting section 16.

When producing a materially bonded connection, the locking section 43 can prevent a joining means, such as adhesive, solder or a melt, from flowing beyond the drive element 210 and entering the inner region of the threaded insert. This can prevent an internal thread of the threaded insert sleeve of the threaded insert from becoming unusable and no longer being available for a subsequent anchoring connection.

The connecting section 16 has an external surface 18 with a polyhedral profile, which has a plurality of surface lines 44 running in the longitudinal direction and is formed via intervening smooth surface sections 36 which extend in the longitudinal direction.

The outer shape of the connecting section 16 of the drive element 210 is cylindrical, or translationally symmetric in the longitudinal direction.

If the drive element 210 is inserted into a corresponding suitable threaded insert sleeve, which has a substantially cylindrical inner surface, then the surface lines 44 are located on the inner surface of the threaded insert sleeve. This can prevent a tilting of the drive element 210 relative to the threaded insert sleeve and enables the position of the drive element 210 in the threaded insert sleeve to be stabilized.

In this stabilised position, channels are formed between the flat sections 36 of the connecting section 36 and the inner surface of the threaded insert sleeve, into which a joining means can flow from the leading end 28 towards a trailing end 30 of the drive element 210. The joining means can also be drawn by capillary action into the channels that are formed.

Because of the polyhedral external profile, the surface lines of which secure the position of the drive element 210 in the case of a materially bonded connection, the channels that are formed can be distributed evenly around the connecting section 16. This enables a very reliable and strong materially bonded connection to be produced.

Due to the locking section 43, whose outer surface in an associated threaded insert preferably rests completely or almost completely against the inner surface of the threaded sleeve, the above mentioned channels can be closed off at the boundary between the locking section 43 and the connecting section 16. This prevents the joining means from spreading beyond the connecting section 16, in the direction of the trailing end 30 of the threaded insert to be produced.

In order to facilitate a better inflow of the joining means, at the leading end 28 of the drive element 210 a corresponding phase can be provided, as shown in the FIGS. 7B and 7D.

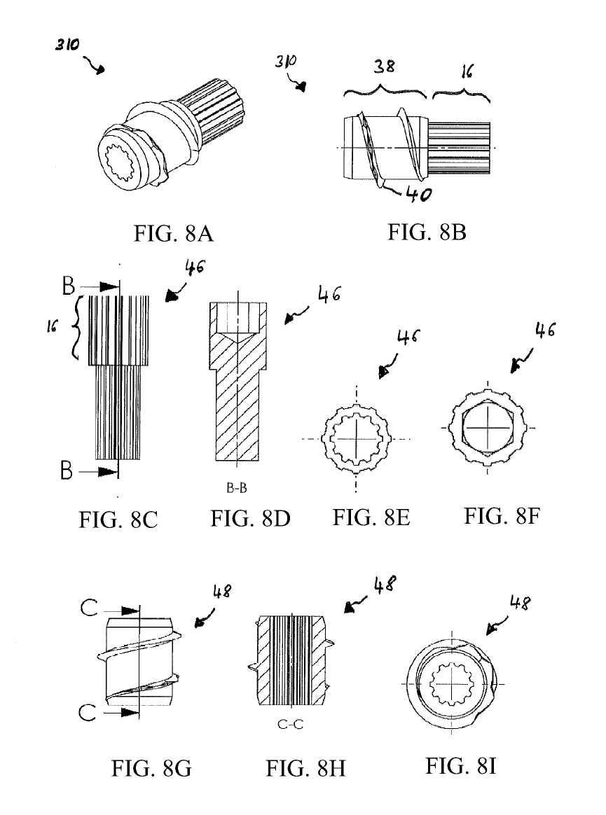

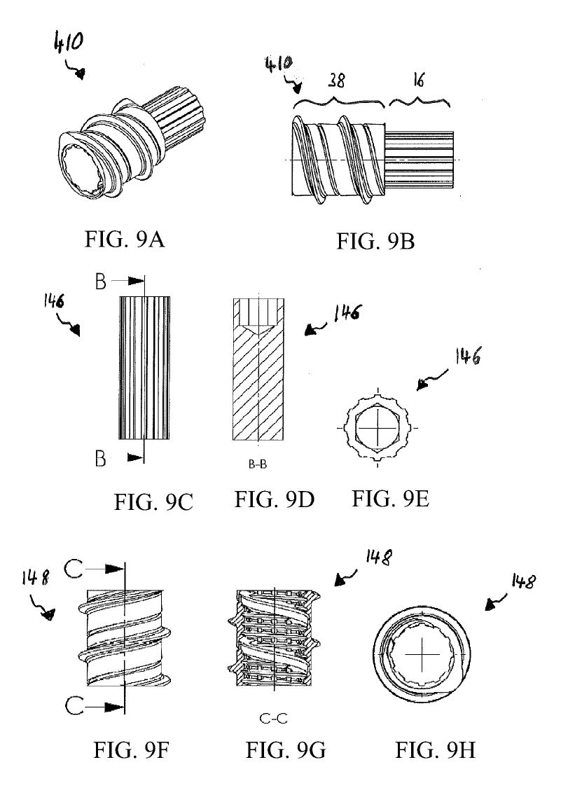

The FIGS. 8A-8I and 9A-9H show a drive element 310, (410) in accordance with a further development according to the invention of the drive element 110 of FIGS. 4A-4C in a perspective external view (FIG. 8A, 9A) and in a side view (FIG. 8B, 9B), which is formed from an inner element 46, (146) and an outer element 48, (148). The outer element 48 has the shape of a sleeve, which is preferably formed as a solid piece, the outer element 148 of the drive element 410 can be wound from a profile strip. The element 48, (148) has an inner profile that forms a mating profile to an outer profile of the inner element 46, (146) on an axial section in the region of the leading end. This allows the outer element 48,(148), after both elements 46,48,(146,148) have been produced separately from each other, to be pushed onto the inner element 46,(146) and connected thereto.

As shown in FIG. 8C, for example, the outer diameter of the inner element 46,(146) in the region of the connecting section 16 can be greater than in the region of the threaded section 38. This allows the outer element 48,(148) to have a larger cross-sectional area than an associated threaded insert sleeve 22, which can increase the stability of the drive element 310,(410) when cutting the thread grooves.

FIGS. 8C-8F show the inner element 46 in an external view (FIG. 8C), in a longitudinal section view for a section along the plane B-B shown in FIG. 8C (FIG. 8D), in a view from below (FIG. 8E) and in a view from above (FIG. 8F). FIGS. 8G-8I show the outer element 48 in an external view (FIG. 8G), in a longitudinal sectional view for a section along the plane C-C shown in FIG. 8G (FIG. 8H) and also in a view from below (FIG. 8I).

In the drive element 310 the connecting section 16 is formed by the inner element 46. The radially outer part of the threaded section 38 is formed by the outer element 48. The inner element 46 need not necessarily have two different outer diameters on different axial sections, but can have a cross-section with a constant outer profile over its entire length, or be translationally symmetric in the longitudinal direction as shown in FIG. 9C. In the connected state (FIGS. 8A-8B) the outer diameter of the drive element 310—as in the case of the drive element 110—is greater in the region of the threaded section 38 than in the region of the connecting section 16, so that the external thread 40 of the threaded section 38 can continue the external thread of an associated threaded insert sleeve 22.

FIGS. 9C-9E show the inner element 146 in an external view (FIG. 9C), in a longitudinal sectional view for a section along the plane B-B shown in FIG. 9C (FIG. 9D), and in a view from above (FIG. 9E). FIGS. 9F-9H show the outer element 148 in an external view (FIG. 9F), in a longitudinal sectional view for a section along the plane C-C shown in FIG. 9F (FIG. 9G) and also in a view from below (FIG. 9H).

In the drive elements 310 and 410 the inner element 46 resp. 146 and the outer element 48 resp. 148 are preferably connected by one of the materially bonded, positive-fitting and/or force-fitting connections described earlier.

The principle of operation and the area of application of the drive elements 310, 410 is similar to those of the drive elements of 10, 110, 210 described earlier, so that they will not be described again here, but rather reference is made to the appropriate previous description.

The outer element 48,(148) can take the form of an axial section of the associated threaded insert sleeve 22 to be continued, for example, the shape of the leading section 32 of FIG. 2B, wherein it may differ from the threaded insert sleeve 22 in a material property, in particular its hardness, and its cross-sectional area.

Unlike in the case of an integral design, due to the multi-piece design of the drive elements 310, 410, the outer element 48,(148) can be produced from a temperable material and be hardened, whereas the inner element 46 (146) can be made from a different material and does not need to be hardened. If the inner element 46, (146) consists of an unhardened and/or non-temperable material, then it may exhibit a low brittleness and thus have a high stability with low risk of breakage. At the same time, only the outer element 48, (148) may be hardened and therefore provide the threaded insert, which can comprise, for example, a corrosion-resistant threaded insert sleeve unsuitable for thread cutting, with a self-tapping capability.

Due to the two-piece design, the inner element 46, (146) and the outer element 48, (148) can be manufactured using different production methods. The inner element 46, (146) can be produced, for example, by a subtractive processing of a solid block. The outer element 48, (310) of the drive elements 310 can also be produced, for example, by a subtractive processing of a solid block. It may also be pressed or sintered.

The outer element 148 of the drive element 410 can be wound from a profile strip. After the wrapping it can then be hardened.

In the previously described exemplary embodiments 10, 110 and 210 of drive elements according to the invention the connecting sections 16 have a cylindrical outer form, which is not substantially different from a circular cylindrical shape. These connecting sections are therefore particularly well suited to a connection to a circular cylindrical or substantially circular cylindrical inside surface of a threaded insert sleeve. The present invention however also comprises drive elements that are not shown and in which the connecting section is either not or not completely cylindrical, for example on account of indentations and/or projections, that are not translationally symmetric in the longitudinal direction.

Regardless of the external shape of the drive element or its connecting section however, in all the drive elements according to the invention an axial section is present, by virtue of material being arranged along a circular line around the longitudinal axis without any material interruption being present, which would extend from the longitudinal axis in the radial direction up to the outer contour and lead to a reduced form stability.

It is pointed out that the above embodiments only represent examples of the present invention and the described features can be of significance in different combinations and such combinations are also encompassed by the present invention. For example, the locking section 43 can also be used in combination with the connecting section 16 of the drive element 10 of FIG. 1. Likewise, for the drive element 110 of FIG. 4, instead of a connecting section with a polygonal outer profile, a connecting section with the profile of the connecting section 16 of FIGS. 1A-1E can also be used.

The scope of protection of the present invention is defined solely by the attached claims.

### REFERENCE LIST

10, 110, 210, 310, 410 drive element
12 holder
14 drive profile
16 connecting section
18 outer surface
20 projections
22, 122 threaded insert sleeve
24 external thread
26 internal thread
28 leading end
30 trailing end
32 leading region
33 recesses
34, 134 threaded insert sleeve
36 smooth surface section
38 threaded section
40 external thread
42 self-tapping teeth
43 locking section
44 surface lines
46, 146 inner element
48, 148 outer element

1. A drive element for transmitting a torque to a threaded insert sleeve comprising:
a holder with a drive profile, in which along a longitudinal axis of the drive element a drive tool for transmitting a torque from the drive tool to the drive element can be received, wherein the longitudinal axis passes through the centre of the drive profile and corresponds to a rotation axis of the drive element, about which the drive element rotates when transmitting the torque from the drive tool to the drive element,
an axial connecting section with an outer surface for forming a connection to the threaded insert sleeve that is one or more of a materially bonded, form-fitting and force-fitting connection, wherein via the outer surface, when a connection to a threaded insert sleeve is formed, a torque can be transmitted from the drive element to the threaded insert sleeve,
wherein the drive element, at least in some sections, comprises a cross-sectional area in which a circular line can be inscribed with a centre, through which the rotational axis passes.

2. The drive element according to claim 1, in which the outer surface of the connecting section is smooth or profiled.

3. The drive element according to claim 1, which is fabricated from a solid workpiece.

4. The drive element according to claim 1, in which the length of the connecting section is one to three times the length of its diameter.

5. The drive element according to claim 1, in which the outer surface of the connecting section comprises projections protruding radially outwards in order to provide a torque transmission via a positive-fitting connection to the threaded insert sleeve.

6. The drive element according to claim 1, wherein the projections extend over the connecting section in a longitudinal direction.

7. The drive element according to claim 1, in which the outer shape of the connecting section is translationally symmetric in the longitudinal direction.

8. The drive element according to claim 1, in which the drive profile of the holder is one of an internal hexalobular profile, an internal polyhedral profile and an internal polygonal profile.

9. The drive element according to claim 1, in which the holder is formed by a through hole or a blind hole.

10. The drive element according to claim 9, wherein the through hole is tapered, at least in some sections, along the longitudinal direction.

11. The drive element according to claim 9, wherein the through hole has a shoulder.

12. The drive element according to claim 1, in which the outer surface of the connecting section
comprises three or more surface lines extending in a longitudinal direction, which lie on an imaginary envelope surface having the form of a perpendicular circular cylinder, and
is spaced apart from the imaginary envelope surface on surface sections, lying between two radially adjacent surface lines, so that imaginary channels are formed between the imaginary envelope surface and the outer surface of the connecting section.

13. The drive element according to claim 12, wherein the outer surface of the connecting section has an outer polyhedral profile or an outer polygonal profile.

14. The drive element according to claim 12, wherein the drive element comprises an axial locking section, which adjoins the connecting section and which in the area of the boundary with the imaginary channels is spaced a smaller distance apart or no distance apart from the continuation of the imaginary envelope surface.

15. The drive element according to claim 1, which further comprises an axial threaded section with an external thread, wherein the threaded section is arranged nearer to a leading end of the drive element than the connecting section, wherein a thread inner diameter of the threaded section is greater than an outer diameter of the connecting section.

16. The drive element according to claim 15, wherein the maximum outer diameter of the threaded section becomes smaller in the direction of the leading end of the drive element.

17. The drive element according to claim 15, wherein the outer thread comprises at least half a turn of the thread, particularly preferably at least one whole turn of the thread.

18. The drive element according to claim 15, wherein the outer thread of the threaded section comprises self-tapping teeth.

19. The drive element according to claim 15, wherein the drive element is constructed of multiple pieces with an inner element having the connecting section and with an outer element for forming the threaded section, which surrounds the inner element at least in some sections.

20. The drive element according to claim 1, wherein the length of the connecting section matches the length of the drive element.

21. The drive element according to claim 1, which is constructed integrally and wholly or partly from a temperable metal.

22. A threaded insert for inserting into a bored hole comprising
a threaded insert sleeve with an external thread,
a drive element according to claim 1,
wherein the connecting section is arranged in the leading half of the threaded insert sleeve inside the threaded insert sleeve, and is connected via one or more of a positive-fitting, a materially bonded and a force-fitting connection, to the threaded insert sleeve, in such a way that a torque transmitted to the drive element via the drive profile is transmitted from the drive element onto the threaded insert sleeve.

23. The threaded insert according to claim 22, in which the inner side of the threaded insert sleeve comprises a plurality of recesses, which are shaped and arranged in correspondence with radially outwardly protruding projections of the connecting section of the drive element, wherein the projections are received in the recesses so that a positive-fitting connection exists.

24. The threaded insert according to claim 22, in which between the outer surface of the connecting section and the threaded insert sleeve a materially bonded connection exists, which is formed by soldering, bonding or welding.

25. The threaded insert according to claim 22, in which the threaded insert sleeve is formed at least partially from a different material than the drive element, wherein the threaded insert sleeve consists of a corrosion-resistant metal or plastic, or comprises one of these materials.

26. The threaded insert according to claim 22, in which the threaded insert sleeve comprises a wound metallic strip or consists thereof.

27. The threaded insert of claim 22, in which the threaded insert sleeve comprises an internal thread.

28. The threaded insert according to claim 22, in which the external thread on the threaded section continues the external thread of the threaded insert sleeve and has the same pitch as the external thread of the threaded insert sleeve.

29. The threaded insert of claim 22, in which the connecting section comprises an external thread, which corresponds to the internal thread of the threaded insert sleeve, and wherein between the connecting section and the threaded insert sleeve a positive-fitting screw connection is formed.

30. Use of a drive element according to claim 1 for transmitting a torque onto a threaded insert sleeve according to claim 22.
